(19) United States
(12) Patent Application Publication
(10) Pub. No.: US 2015/0219076 A1
(43) Pub. Date: Aug. 6, 2015

(54) WIND TURBINE ROTOR SHAFT ARRANGEMENT WITH EXPANDING ATTACHMENT PORTION

(71) Applicant: AKTIEBOLAGET SKF (publ), Göteborg (SE)

(72) Inventors: Hans Wendeberg, Vastra Frolunda (SE); Håkan Leander, Torslanda (SE)

(21) Appl. No.: 14/422,718

(22) PCT Filed: Aug. 19, 2013
(86) PCT No.: PCT/SE2013/000129

§ 371 Date: Feb. 20, 2015

(30) Foreign Application Priority Data
Aug. 21, 2012 (SE) 1200501-3

(51) Int. Cl. F03D 11/00; F03D 1/00

(52) U.S. Cl. CPC F03D 11/0008; F03D 1/001; F03D 11/0075

(57) ABSTRACT

A wind turbine rotor shaft arrangement comprising a rotor shaft, a first support structure for supporting the rotor shaft, and a first rolling bearing arranged to support the rotor shaft in relation to the first support structure. The first rolling bearing comprises an inner ring, an outer ring, a set of rolling elements, and an attachment portion for securing the inner ring. The attachment portion comprises an radially outer support surface, wherein the radially outer support surface of the attachment portion is expanded radially outwards for securing the inner ring by an expansion member being driven into the attachment portion. A method for manufacturing a wind turbine rotor shaft arrangement.

### CROSS REFERENCE TO RELATED APPLICATIONS

This is a National Stage Application claiming the benefit of International Application Number PCT/SE2013/000129 filed on 19 Aug. 2013 (19.08.2013), which claims the benefit of Sweden Patent Application Serial Number 1200501-3, filed on 21 Aug. 2012 (21.08.2012), both of which are incorporated herein by reference in their entireties.

### FIELD OF THE INVENTION

The present invention relates to rolling bearing arrangements for wind turbines, and more specifically to a wind turbine rotor shaft arrangement comprising a rotor shaft for supporting wind turbine blades, which rotor shaft is supported at a first support point with a rolling bearing comprising an inner ring attached to an attachment portion of the wind turbine rotor shaft arrangement.

The present invention also relates to a method for manufacturing a wind turbine rotor shaft arrangement.

### BACKGROUND ART

Due to the large dimensions and weight of wind turbines, the load bearing capabilities and performance of the bearing arrangement supporting the rotor shaft and wind turbine blades is of high importance which results in high demands on correct alignment and position of the bearings. Typically, for a wind turbine of horizontal, or near horizontal, rotor shaft type, the bearing arrangement must support both axial and radial loads, wherein the axial loads commonly comprises axial loads transferred from the turbine blades during operation as well as axial loads arising from the weight of the rotor shaft and turbine blade arrangement which is commonly mounted with a tilted angle in relation to the horizontal plane in order to reduce the risk of collision between the turbine blades and the wind turbine tower.

Moreover, the weight and size of the components as well as the location of the rotor arrangement in tower like structures increase the cost for manufacturing, mounting, and servicing of the wind turbines. In particular, the attachment of load bearing rolling bearings to the rotor shaft and to support structures is cumbersome and costly, typically involving heating techniques of members, such as the inner ring of a rolling bearing to be mounted, in order to provide suitable attachment and pre-stressing, while the precision requirements for alignment and orientation of the rolling bearing in relation to the shaft and/or support structure are high. As a result, the mounting process takes long time and requires auxiliary equipment for heating and alignment control measurements. Also, in known solutions, dismounting of load bearing rolling bearings from the rotor shaft or from support structures is cumbersome and time-consuming.

### SUMMARY OF THE INVENTION

In view of the above-mentioned and other drawbacks of the prior art, a general object of the present invention is to provide a wind turbine rotor shaft arrangement which allows for improved mounting/dismounting of the rolling bearing in relation to the rotor shaft and/or support structure supporting the rotor shaft, and a method for manufacturing a wind turbine rotor shaft arrangement.

These and other objects are met by the subject matters provided in the independent claims. Preferred embodiments of the invention are presented in the dependent claims.

According to a first aspect thereof, the present invention relates to a wind turbine rotor shaft arrangement, e.g. of horizontal or near horizontal type, comprising a rotor shaft for supporting wind turbine blades, a non-rotating first support structure for supporting the rotor shaft, which first support structure is arranged to be mounted to a wind turbine nacelle framing, and a first rolling bearing arranged to support the rotor shaft in relation to the first support structure at a first support point, which first rolling bearing comprises an inner ring, an outer ring, and a set of rolling elements arranged in an intermediate configuration between the inner and outer rings. The wind turbine rotor shaft arrangement further comprises an attachment portion for securing the inner ring, which attachment portion comprises a radially outer support surface. Furthermore, a radially inner support surface of the inner ring is abutting the radially outer support surface, and the radially outer support surface of the attachment portion is expanded radially outwards for securing the inner ring by an expansion member being driven into the attachment portion.

The invention is based on the realization by the inventors that an improved and more efficient mounting of a wind turbine rotor shaft arrangement is realized by securing the inner ring of the load bearing rolling bearing to an attachment portion of e.g. a rotor shaft or support structure by expanding the attachment portion radially outwards with an expansion member in order to provide pressure fit between the attachment portion and the inner ring. Thereby, the inner ring may advantageously be arranged in the correct position and alignment in relation to the attachment portion before the attachment portion is expanded. Hence, mounting may be considerably facilitated by separating the positioning and alignment step from the attachment step during the mounting process.

By being driven into the attachment portion, the expansion member ensures that the attachment portion remains in its radially expanded state such that secure and reliable attachment between the attachment portion and inner ring is provided during operation. A further advantage with the solution is that the arrangement may be dismounted in a corresponding reversed manner by removing the expansion member. Thereby, the radial dimension of the attachment portion is reduced such that the inner ring of the rolling bearing is freed in relation to the attachment portion in the axial direction.

The wind turbine rotor shaft arrangement further allows for adjustment of the pre-stressing level of the inner ring of the rolling bearing in an improved and simplified manner by adjustment of the amount by which the expansion member is driven into the attachment portion during e.g. servicing of the arrangement.

For example, the expansion of the attachment portion in the radial outward direction provided by the expansion member is between 1 and 2000 microns, or between 5 and 500 microns.

According to an exemplifying embodiment, the attachment portion comprises an expansion chamber, and the expansion member is driven into the expansion chamber of the attachment portion. Thereby, the expansion member may be advantageously adapted to fit inside the expansion member of the attachment portion in order to provide suitable expansion of the attachment portion. For example, the expansion member is axially driven into the expansion chamber along the rotational axis of the rotor shaft.

According to a further embodiment, the expansion chamber and expansion member are coaxially arranged. Moreover, according to an embodiment, the expansion chamber comprises a receiving opening into which the expansion member is inserted during mounting.

For example, the expansion chamber is arranged in the attachment portion radially inside the radially outer support surface of the attachment portions. Furthermore, according to an exemplifying embodiment, the expansion chamber is arranged directly radially inside the radially outer support surface of the attachment portion such that it is axially aligned with the radially outer support surface. The expansion member may also be arranged axially off-set in relation to the radially outer support surface of the attachment portion.

According to a further exemplifying embodiment, the expansion chamber has an inward shape comprising tapered contacting surfaces. Thereby, the expansion chamber is configured to expand during the insertion of the expansion member and remain expanded while the expansion member is in position. For example, according to an exemplifying embodiment, the contacting surface of the expansion chamber facing in a radially inward direction has a tapered shape having a decreasing radial dimension in an axial insertion direction of the expansion member into the expansion chamber.

According to various embodiments, the expansion chamber has an internal shape corresponding to a cone, pyramid, or corresponding shapes formed by connecting a polygonal base and an apex point, wherein the contacting surface defining the expansion chamber in the radial direction corresponds to the tapered sides of the cone, pyramid or corresponding shape. Furthermore, the shape of the expansion chamber may have a rotational symmetry about an axis coinciding or being parallel with the rotational axis of the rotor shaft, such as being cone-shape.

According to yet an exemplifying embodiment, the expansion member has an outward shape comprising a tapered contacting surface. Thereby, the expansion member is configured to expand the attachment portion during the insertion of the expansion member and maintain the attachment portion in its expanded state while the expansion member is in position.

For example, according to an exemplifying embodiment, the outer contacting surface of the expansion member facing in a radially outward direction has a tapered shape having a decreasing radial dimension in an axial insertion direction of the expansion member into the expansion chamber.

According to various embodiments, the expansion chamber has an internal shape corresponding to a cone, pyramid, or corresponding shapes formed by connecting a polygonal base and an apex point, wherein the surface defining the chamber in the radial direction corresponds to the tapered sides of the cone, pyramid or corresponding shape, and wherein the portion of the shape including the apex may be cut off. Furthermore, the shape of the expansion chamber may have a rotational symmetry about an axis coinciding or being parallel with the rotational axis of the rotor shaft, such as being cone-shape.

According to an exemplifying embodiment, the inward shape of the expansion chamber cooperates with the outward shape of the expansion member. For example, according to various embodiments, the cross-sectional shape of the expansion chamber and/or the expansion member taken in a plane having a normal direction coinciding with the rotational axis of the rotor shaft may be circular, oval, triangular, square, or polygonal.

According to an exemplifying embodiment of the wind turbine rotor shaft arrangement, the attachment portion is formed by the rotor shaft. Thereby, the inner ring of the first rolling bearing is securely attached to the rotor shaft being supported by a non-rotating surrounding support structure, wherein the attachment portion forms part of the rotor shaft.

According to an alternative exemplifying embodiment of the wind turbine rotor shaft arrangement, the attachment portion is formed by the support structure. Thereby, the inner ring of the first rolling bearing is securely attached to the support structure, such as a radially inner non-rotating support structure of a radially outer circumferential hollow rotor shaft or hub, wherein the attachment portion forms part of the support structure.

Furthermore, according to an exemplifying embodiment, the wind turbine rotor shaft arrangement further comprises a non-rotating second support structure for supporting the rotor shaft, which second support structure is arranged to be mounted to the wind turbine nacelle framing, and a second rolling bearing arranged to support the rotor shaft in relation to the second support structure at a second support point, which second rolling bearing comprises an inner ring, an outer ring, and a second set of rolling elements arranged in an intermediate configuration between the inner and outer rings. The wind turbine rotor shaft arrangement further comprises a second attachment portion for securing the inner ring of the second rolling bearing, which second attachment portion comprises a second radially outer support surface. Furthermore, a second radially inner support surface of the inner ring of the second rolling bearing is abutting the radially outer support surface, wherein the second radially outer support surface of the second attachment portion is expanded radially outwards for securing the inner ring of the second rolling bearing by a second expansion member being driven into the second attachment portion.

According to a further aspect of the present invention, it relates to a wind turbine arrangement comprising the wind turbine rotor shaft assembly according to any one of the embodiments described above, which wind turbine arrangement comprises a nacelle framing, wherein the rotor shaft is supported by and mounted to the nacelle framing via the first support structure.

According to a further aspect thereof, the present invention relates to a method for manufacturing a wind turbine rotor shaft arrangement comprising a rotor shaft for supporting wind turbine blades and a non-rotating first support structure supporting the rotor shaft at a first support point via a first roller bearing comprising an inner ring, an outer ring, and a set of rolling elements arranged in an intermediate configuration between the inner and outer rings, wherein the method comprises:
mounting the inner ring of the first rolling bearing to an attachment portion at the first support point, which attachment portion comprises an radially outer support surface, wherein a radially inner support surface of the inner ring is abutting the radially outer support surface, and
securing the inner ring of the first rolling bearing to the attachment portion by driving an expansion member into the attachment portion, wherein the expansion member expands the attachment portion in a radially outward direction.

The method advantageously allows for improved and more reliable mounting of e.g. a load bearing rolling bearing to a rotor shaft or support structure. The method is further advantageous in similar manners are described in relation to the first aspect of the invention.

According to an exemplifying embodiment of the method, the step of mounting the inner ring of the first rolling bearing comprises axially sliding the inner ring in relation to the attachment portion to the radially outer support surface, wherein the inner ring has a loose fitting tolerance in relation to attachment portion. For example, the loose fitting tolerance between the inner ring and the attachment portion simplifies the alignment and correct position of the inner ring prior to fixation of the inner ring to the attachment portion by expansion of the attachment portion. According to a further exemplifying embodiment of the method, the step of mounting the inner ring of the first rolling bearing further comprises axially positioning the inner ring in relation to the attachment portion and aligning the inner ring in relation to the attachment portion.

According to a further exemplifying embodiment of the method, the step of securing the inner ring comprises inserting the expansion member into a receiving opening of an expansion chamber and driving the expansion member into the expansion chamber. In other words, the step of securing the inner ring comprises expanding the attachment portion of the rotor shaft or the attachment portion of the non-rotating support structure, wherein the expansion of the attachment portion creates an interface between the inner ring and the attachment portion having a contact pressure which hinder, or eliminate, motion between the attachment portion and the inner ring.

According to yet an exemplifying embodiment of the method, the method further comprises providing an lubricant between a contacting surface of the expansion member and the contacting surface of the expansion chamber. The lubricant may according to an embodiment comprise oil which is provided by a pressure-fed oil lubrication system. Moreover, the attachment portion and/or expansion member may comprise an internal channel structure for pressure injection of oil between the contacting surfaces of the expansion member and expansion chamber. Advantageously, an oil film reduce friction and allow for a more efficient mounting process requiring less axial driving force may be provided. The channel structure may also be used with a pressure-oil lubrication system for dismounting the wind turbine rotor shaft arrangement, wherein the expansion member is removed in order to detach the inner ring of the first rolling bearing from the gripping engagement of the expanded attachment portion. The channel structure may further comprise an outlet at the contacting surfaces of the expansion member and/or expansion chamber of the attachment portion.

Furthermore, according to an exemplifying embodiment of the method, it further comprises pre-stressing the inner ring by expanding the attachment portion in a radially outward direction by the expansion member.

According to a further exemplifying embodiment, the method comprises an additional following step comprising further expanding the attachment portion for adjusting the internal clearance and/or internal bearing preload. According to a further embodiment, the method comprises reducing the expansion of the attachment portion by adjusting the axial position of the expansion member in order to reduce the internal clearance and/or internal bearing preload, or to release the inner ring. Furthermore, the inner ring of the first bearing may be released by removing the expansion member and axially sliding the rolling bearing away from the attachment portion.

Generally, other objectives, features, and advantages of the present invention will appear from the following detailed disclosure, from the attached dependent claims as well as from the drawings are equally possible within the scope of the invention.

### BRIEF DESCRIPTION OF DRAWINGS

Embodiments of the invention will now be described, by way of example, with reference to the accompanying drawings, wherein:

FIG. 1 is a schematic cross-sectional view of an embodiment of the wind turbine rotor shaft arrangement according to the present invention.

FIG. 2 is a schematic cross-sectional view of an embodiment of the wind turbine rotor shaft arrangement according to the present invention.

FIG. 3a is a schematic partial side view of a wind turbine comprising an embodiment of the wind turbine rotor shaft arrangement according to the present invention.

It should be understood that the drawings are not true to scale and, as is readily appreciated by a person skilled in the art, dimensions other than those illustrated in the drawings are equally possible within the scope of the invention.

### DETAILED DESCRIPTION OF EMBODIMENTS OF THE INVENTION

In the drawings, similar, or equal elements are referred to by equal reference numerals.

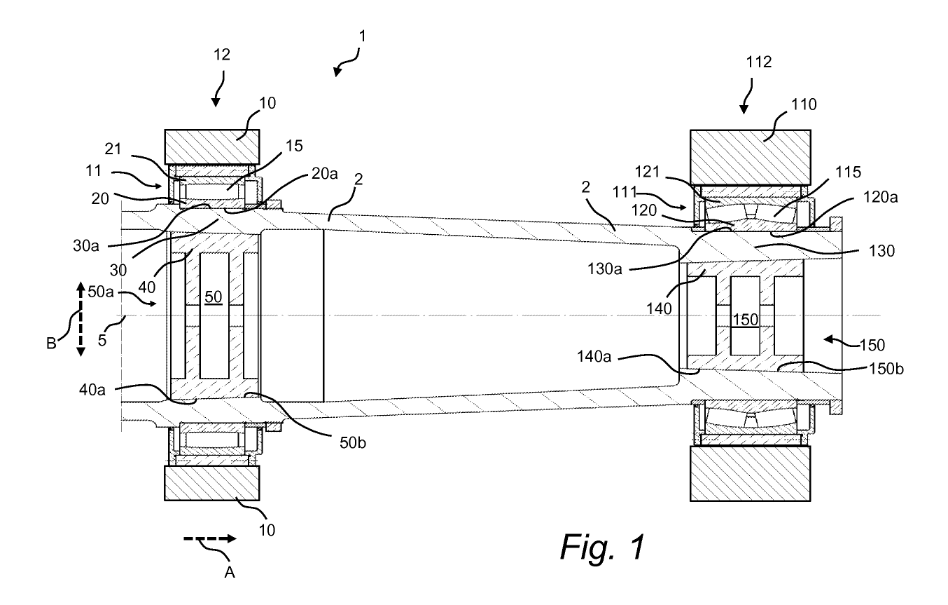

In FIG. 1, a wind turbine rotor shaft arrangment 1 comprising a rotor shaft 2 for supporting wind turbine blades of a wind turbine is illustrated, which rotor shaft 2 extends axially along a rotor axis 5. The rotor shaft 2 is arranged to be rotatably mounted in a nacelle framing arranged in the top of a tower-like support structure of a wind turbine having a horizontal, or near horizontal, orientation of the rotor shaft. However, the wind turbine rotor shaft arrangement 1 is not limited to a horizontal type orientation and may also be used in wind turbines appliations involving tilted and vertical type rotor shaft orientations. The orientation of the rotor shaft is defined in relation to its intended mounted operational position in a nacelle framing of an operational wind turbine.

As illustrated, a non-rotating first support structure 10 is provided for supporting the rotor shaft 2 in relation to a wind turbine nacelle framing. For example, the support structure 10 is arranged to the mounted to a wind turbine nacelle framing, or the support structure 10 forms part of a wind turbine nacelle framing structure. A first rolling bearing 11 is further provided to support the rotor shaft 2 in relation to the first support structure 10 axially and/or radially. The first rolling bearing 11 rotatably supports and connects the rotor shaft 2 to the first support structure 10 at a first support point 12. The first rolling bearing comprises an inner ring 20, an outer ring 21, and a set of rolling elements formed of rollers 15 arranged in an intermediate configuration between the inner and outer rings. As shown, the first bearing is a single row toroidal bearing. However, the first bearing may be a single or double row bearing, or comprise a plurality of rows of rolling elements, such as symmetrical or tapered rollers. The first bearing may further be a self-aligning bearing, such as a spherical or toroidal bearing having curved contacting surfaces of the rolling elements and the inner and outer raceways, a tapered roller bearing, or a thrust bearing having suitable contact angle.

As further illustrated, the arrangement 1 comprises an attachment portion 30 for securing the inner ring 20, which attachment portion forms part of the rotor shaft 2 and comprises a radially outer support surface 30a. A radially inner support surface 20a of the inner ring abuts the radially outer support surface 30a which is expanded radially outwards by an expansion member 40. The expanded radially outer support surface 30a of the attachment portion 30 presses against the radially inner support surface 20a such that the inner ring 20 is securely lock in relation to the rotor shaft, both rotationally and axially.

As shown, the expansion member 40 is arranged in an expansion chamber 50 formed inside the rotor shaft 2, and has tapered shaped with inclined contacting surfaces 40a arranged to press against and expand the attachment portion 30 in the radially outward direction, as indicated by arrow B, when being driven into and arranged in the expansion chamber 50. Hence, during mounting, the expansion member 40 is inserted with force, in an axial insertion direction A, into an axially facing receiving opening 50a of the expansion chamber 50, wherein contacting surface 50b of the expansion chamber 50 cooperates with and has a corresponding shape in relation to the contacting surface 40a of the expansion member 40. During the insertion, when the expansion member 40 is driven into the expansion chamber 50, the contacting surface 40a slide at least partially against the contacting surface 50b of the expansion chamber 50 and exerts a radial pressure directed outwards deforming the attachment portion 30 such that the radial dimension of the radially outer support surface 30a increase. Depending on the intended application, the attachment portion may be elastically and/or plastically deformed by the expansion member 40 in order to secure the inner ring to the attachment portion.

As further illustrated in FIG. 1, the rotor shaft 2 of the wind turbine rotor shaft arrangement 1 is provided with a second rolling bearing 111 being arranged to support the rotor shaft 2 in relation to a second support structure 110 at a second support point 112, which second rolling bearing comprises an inner ring 120, an outer ring 121, and a second set of rolling elements 115 arranged in an intermediate configuration between the inner and outer rings. The second rolling bearing 111 is secured to a second attachment portion 130 being arranged in a similar manner as described in relation to the first rolling bearing 11 and attachment portion 30.

As illustrated, the second attachment portion 130 comprises a second radially outer support surface 130a abutting a second radially inner support surface 120a of the inner ring 120. The second attachment portion 130 further comprises a second inwardly arranged expansion chamber 150 having an tapered inwardly facing contacting surface 150b abutting a tapered outwardly facing contacting surface 140a of second expansion member 140.

For example, the first and second rolling bearings 11 and 111 may be separated a distance, which distance e.g. is equal to or exceeds 50%, or 75%, or 100%, or 150% of the outer diameter of the rotor shaft 2 at the first support point 12.

As further shown, the wind turbine rotor shaft arrangment 1 is provided with first and second rolling bearings 11 and 111 having different size, load bearing, and self-aligning capacity. Thereby, the arrangement is configured for different operation and different axial load bearing capacity in opposing axial directions along the rotor axis 5.

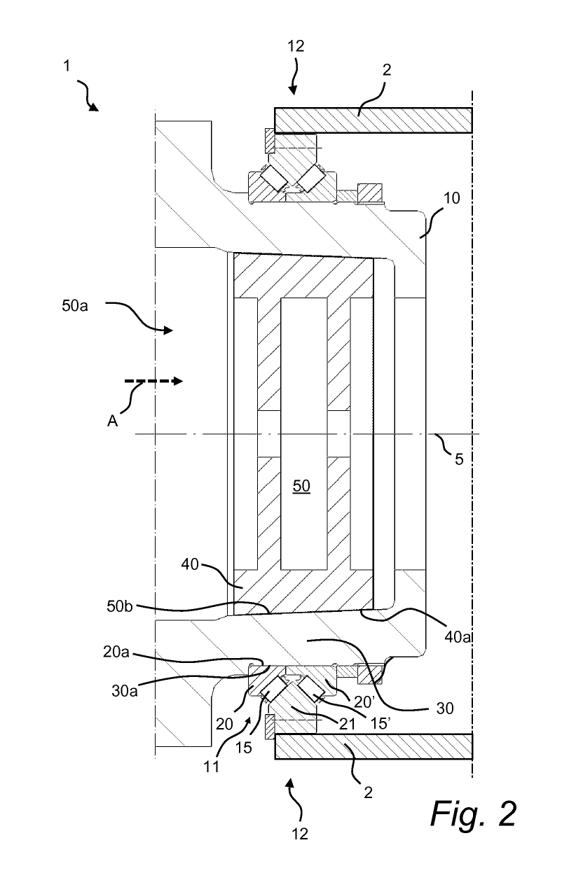

In FIG. 2, a schematic perspective view of an embodiment of the wind turbine rotor shaft arrangement 1 according to the present invention is shown, which is based on an alternative design in relation to the embodiment described in relation to FIG. 1. However, the embodiment in FIG. 2 is arranged in a corresponding manner as described in relation to wind turbine rotor shaft arrangement 1 as described in relation to FIG. 1, if not stated or illustrated differently.

The wind turbine rotor shaft arrangement 1 in Fig, 2, mainly differs from the embodiment in FIG. 1 in that the attachment portion 30 forms part of the support structure 1 which is arranged inside hollow rotor shaft 2. Thereby, the expansion chamber is formed in the support structure 10 and the expansion member is inserted into receiving opening 50a during mounting. As further shown, the first rolling bearing 11 is a double row bearing comprising an additional row of rollers 15′, and an additional inner ring 20′, wherein the additional inner ring 20′ is arranged adjacent the inner ring 20 and secured to the attachment portion 30 in similar manners as the inner ring 20.

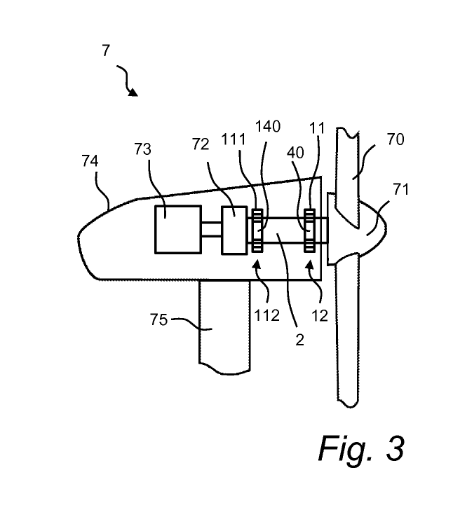

In FIG. 3, a schematic partial side view of a wind turbine assembly 7 comprising an embodiment of the wind turbine rotor shaft arrangement 1 according to the present invention is shown. As illustrated, wind turbine blades 70 and a hub unit 71 are attached to rotor shaft 2 which is supported at a first support point 12 by a first rolling bearing 11 and at a second support point 112 by a second rolling bearing 111. The arrangement 1 is arranged in a wind turbine framing construction, or housing, 74, arranged on a tower-like support member 75. Furthermore, the rotor shaft 2 is connected to a gear box 72 for shifting the rotational speed of the rotor shaft 2 before coupling the rotation of the rotor shaft 2 to a generator 73. Alternatively, the rotor shaft may be directly coupled to the generator without shifting the rotational speed of the rotor shaft with a gear box.

As further schematically illustrated, each one of the first and second rolling bearing 11 and 111 are secured to an attachment portion of the rotor shaft 2 by means of the a respective expansion member 40 and 140.

Even though the rotor shaft 2 of the wind turbine rotor shaft arrangement 1 is supported by a first and second rolling bearings 11 and 111 according to the design schematically illustrated in FIG. 3, there are various wind turbine bearing designs that are possible according to the present invention. For example, the rotor shaft 2 may be support by a two-point wind turbine bearing design, wherein the two points are formed of the first and second support points 12 and 112 and the respective first and second rolling bearings 11 and 111, and wherein a gear box for shifting the rotational speed only acts as a torque converter. The second rolling bearing 111 supporting the rotor shaft 2 may also be integrally formed in the gear box such that the gear box itself supports the rotor shaft 2.

For example, according to an exemplifying embodiment, the rotor shaft 2 of the wind turbine rotor shaft arrangement is supported by a three-point wind turbine bearing design, wherein the second rolling bearing forms part of, or is integrated in, a gear box, which gear box comprises a third rolling bearing which acts to support the rotor shaft 2 and which is separated from the second rolling bearing and arranged at a third support point along the rotor axis.

Moreover, the axially separated first and second rolling bearings 11 and 111 may be arranged to have substantially no axial play, or be arranged with a suitable axial play, depending on the preferred wind turbine rotor shaft design.

Furthermore, it should be noted that the invention has mainly been described above with reference to a few embodiments. However, as is readily appreciated by a person skilled in the art, other embodiments than the ones disclosed above are equally possible within the scope of the invention, as defined by the appended patent claims.

In the claims, the word “comprising” does not exclude other elements or steps, and the indefinite article “a” or “an” does not exclude a plurality. A single apparatus or other unit may fulfill the functions of several items recited in the claims. The mere fact that certain features or method steps are recited in mutually different dependent claims does not indicate that a combination of these features or steps cannot be used to advantage.

1. A wind turbine rotor shaft arrangement, comprising:
a rotor shaft for supporting wind turbine blades,
a non-rotating first support structure for supporting the rotor shaft, which first support structure is arranged to be mounted to a wind turbine nacelle framing,
a first rolling bearing arranged to support the rotor shaft in relation to the first support structure at a first support point, which first rolling bearing comprises an inner ring, an outer ring, and a set of rolling elements arranged in an intermediate configuration between the inner and outer rings, and
an attachment portion for securing the inner ring, which attachment portion comprises a radially outer support surface,
wherein a radially inner support surface of the inner ring is abutting the radially outer support surface,
wherein the radially outer support surface of the attachment portion is expanded radially outwards for securing the inner ring by an expansion member being driven into the attachment portion.

2. The wind turbine rotor shaft arrangement according to claim 1, wherein the attachment portion comprises an expansion chamber and wherein the expansion member is driven into the expansion chamber of the attachment portion.

3. The wind turbine rotor shaft arrangement according to claim 2, wherein the expansion chamber has an inward shape comprising tapered contacting surfaces.

4. The wind turbine rotor shaft arrangement according to claim 1, wherein the expansion member has an outward shape comprising tapered contacting surfaces.

5. The wind turbine rotor shaft arrangement according to claim 1 wherein the expansion chamber has an inward shape comprising tapered contacting surfaces and wherein the expansion member has an outward shape comprising tapered contacting surfaces, wherein the inward shape of the expansion chamber cooperate with the outward tapered shape of the expansion member.

6. The wind turbine rotor shaft arrangement according to claim 1, wherein the attachment portion is formed by the rotor shaft.

7. The wind turbine rotor shaft arrangement according to claim 1, wherein the attachment portion is formed by the support structure.

8. The wind turbine rotor shaft arrangement according to claim 1, further comprising:
a non-rotating second support structure for supporting the rotor shaft, wherein the non-rotating second support structure is arranged to be mounted to the wind turbine nacelle framing,
a second rolling bearing arranged to support the rotor shaft in relation to the second support structure at a second support point, which second rolling bearing comprises an inner ring, an outer ring, and a set of rolling elements arranged in an intermediate configuration between the inner and outer rings, and
a second attachment portion for securing the inner ring of the second rolling bearing, which second attachment portion comprises an second radially outer support surface,
wherein a second radially inner support surface of the inner ring of the second rolling bearing is abutting the radially outer support surface,
wherein the second radially outer support surface of the second attachment portion is expanded radially outwards for securing the inner ring of the second rolling bearing by a second expansion member being driven into the second attachment portion.

9. A wind turbine assembly including a wind turbine rotor shaft arrangement, comprising:
a rotor shaft for supporting wind turbine blades,
a non-rotating first support structure for supporting the rotor shaft, which first support structure is arranged to be mounted to a wind turbine nacelle framing,
a first rolling bearing arranged to support the rotor shaft in relation to the first support structure at a first support point, which first rolling bearing comprises an inner ring, an outer ring, and a set of rolling elements arranged in an intermediate configuration between the inner and outer rings, and
an attachment portion for securing the inner ring, which attachment portion comprises a radially outer support surface,
wherein a radially inner support surface of the inner ring is abutting the radially outer support surface,
wherein the radially outer support surface of the attachment portion is expanded radially outwards for securing the inner ring by an expansion member being driven into the attachment portion
a nacelle framing, wherein the rotor shaft is supported by and mounted to the nacelle framing via the first support structure.

10. A method for manufacturing a wind turbine rotor shaft arrangement comprising a rotor shaft for supporting wind turbine blades and a non-rotating first support structure supporting the rotor shaft at a first support point via a first roller bearing comprising an inner ring, an outer ring, and a set of rolling elements arranged in an intermediate configuration between the inner and outer rings, the method comprising steps of:
mounting the inner ring of the first rolling bearing to an attachment portion at the first support point, which attachment portion comprises an radially outer support surface, wherein a radially inner support surface of the inner ring is abutting the radially outer support surface, and
securing the inner ring of the first rolling bearing to the attachment portion by driving an expansion member into the attachment portion, wherein the expansion member expands the attachment portion in a radially outward direction.

11. The method according to claim 10, wherein the step of mounting the inner ring of the first rolling bearing further comprises a step of axially sliding the inner ring in relation to the attachment portion to the radially outer support surface, wherein the inner ring has a loose fitting tolerance in relation to attachment portion.

12. The method according to claim 10, wherein the step of securing the inner ring further comprises steps of inserting the expansion member into a receiving opening of an expansion chamber and driving the expansion member into the expansion chamber.

13. The method according to claim 12, further comprising a step of providing a lubricant between a contacting surface of the expansion member and the a contacting surface of the expansion chamber.

14. The method according to claim 10, further comprising a step of pre-stressing the inner ring by expanding the attachment portion in an radially outward direction by the expansion member.

15. The method according to claim 10, further comprising a step of adjusting the internal clearance of the first roller bearing by adjusting the axial position of the expansion member in relation to the attachment portion.
